(19) United States
(12) Patent Application Publication
(10) Pub. No.: US 2024/0025459 A1
(43) Pub. Date: Jan. 25, 2024

(54) PROCESS FOR THE MODULAR MANUFACTURING OF A CAR BODY SHELL OF A RAIL VEHICLE, AND CAR BODY SHELL

(71) Applicant: Siemens Mobility GmbH, München (DE)

(72) Inventors: Rene Günther, Duisburg (DE); Stephan Bissels, Straelen (DE); Bodo Osterloh, Krefeld (DE); Alexander Trapp, Schermbeck (DE); Jens Cuylen, Wuppertal (DE)

(21) Appl. No.: 18/257,344

(22) PCT Filed: Dec. 3, 2021
(86) PCT No.: PCT/EP2021/084147

§ 371 Date: Jun. 14, 2023

(30) Foreign Application Priority Data
Dec. 21, 2020 (DE) 10 2020 216 382.0

(51) Int. Cl. B61D 17/04

(52) U.S. Cl. CPC B61D 17/045

(57) ABSTRACT

A method for modular manufacturing of a car body shell of a rail vehicle includes manufacturing at least two directly adjoining large assemblies of the car body shell in parallel. The large assemblies are selected from among the group including an underframe, a side wall, a roof, an end wall, and a head of the body. The at least two large assemblies manufactured in parallel as described above are joined by structural adhesive bonding. A car body shell of a rail vehicle manufactured by the method is also provided.

The invention relates to a method for modular production of a car body shell of a rail vehicle. Such a method is known, for example, from EP 1 958 844 A1 which relates to a method for producing an assembly of a train for conveying passengers, i.e. rail vehicles of any suitable type such as high-speed trains, regional trains, trams and metros. In the case of a car body shell produced according to this method, for example, a head module, two carrier modules fitted in each case with bogies and an intermediate module are provided which is embodied as a passenger compartment. The individual modules of the car body shell are connected to one another by joining.

The assemblies underframe, side wall, roof, end wall and head of the rail vehicle can generally be referred to as “large assemblies”. They form the car body shell of the rail vehicle which forms the complete supporting body structure. This takes on the necessary supporting function itself, any payload and all the components mounted on the car body shell.

It is known in the prior art to embody the interfaces of large assemblies which directly adjoin one another as welded connections. The large assemblies and the car body shell constructed from them are thus primarily welded steel or aluminum structures which are produced in an integral or differential design.

In the case of the integral design, large-format extruded profiles are largely used in which suitable fastening possibilities for interfaces and equipment items are integrated. In the case of the differential design, a supporting steel or aluminum skeleton is initially created onto which metal sheets for paneling are subsequently fitted. Fastening possibilities for interfaces and equipment items are provided on the supporting structure.

Joining by welding is one of the most important and widespread joining methods in rail vehicle construction. This joining method is, however, time- and cost-intensive in terms of the necessary alignment and finishing processes which are necessary in particular as a result of thermal stresses and deformation during welding in traditional car body shell production. The joining method “welding” thus does not enable the use of different materials for the various large assemblies.

Proceeding from this, the object on which the invention is based is to indicate a method for modular production of a car body shell of a rail vehicle as well as a car body shell in the case of which alignment and finishing processes can be largely dispensed with.

This object is achieved by a method for modular production of a car body shell of a rail vehicle with the consecutive steps:
a) parallel manufacturing of at least two large assemblies, directly adjoining one another, of the car body shell which are selected from the group which comprises an underframe, a side wall, a roof, an end wall and a head of the car body shell,
b) joining the at least two large assemblies manufactured parallel to one another from step a) by means of structural bonding.

It should be emphasized that the individual large assemblies to be joined by means of structural bonding, such as the underframe, a side wall, the roof, the end wall and the head, depending on the configuration of the car body shell, can be produced in differential or integral design if the relevant large assembly is to be manufactured from metal. It is likewise possible that certain large assemblies, such as, for example, the head, are produced from fiber-reinforced plastic. It is vital that, irrespective of the manufacturing method or material used in each case for the individual large assemblies, the large assemblies arranged in each case adjacently are joined to one another at the end of the manufacture of the car body shell by means of structural bonding or the entire car body shell is composed of large assemblies which are connected to one another in each case by means of structural bonding to one another. The structural bonding can be restricted to only two of the large assemblies which directly adjoin one another. In principle, all designs are possible for all large components independently of one another, e.g. differential or integral design or manufacture from FRP.

When joining together two large assemblies which have been produced in integral design (aluminum extruded profiles), it is preferred that edge portions, facing one another, of large assemblies to be joined to one another are formed from hollow chamber profiles. The sides, facing one another, of the hollow chamber profiles have a threading apparatus for prepositioning of the hollow chamber profiles relative to one another and sides, which are assigned to an outer side of the car body shell, of the hollow chamber profiles are connected by means of a sheet metal or profile strip which overlaps in each case with the hollow chamber profiles, the edge portions, which face the hollow chamber profiles, of which sheet metal or profile strip are structurally bonded in each case to the hollow chamber profiles.

In order to provide a flush outer skin of the car body shell, it is preferred that the edge portions, facing one another, of the hollow chamber profiles have in each case on their sides assigned to an outer side of the car body shell a shoulder in the region of which the sheet metal or profile strip is structurally bonded to the respective hollow chamber profile, wherein the height of the shoulder corresponds to the height extent of the sheet metal or profile strip and the structural bonding layer. In the case of this embodiment, the outer sides of the two hollow chamber profiles and of the sheet metal or profile strip lie in a joint plane.

The threading apparatus can be formed, for example, by a tongue/groove apparatus which is arranged on a side of the hollow chamber profiles assigned to an inner side of the car body shell. In this regard, an inner side of the hollow chamber profiles is closed by the threading apparatus and the transition region between the hollow chamber profiles can only be accessed from the outer side. In the case of this embodiment, it is preferably provided that in step b) an intermediate profile is placed between the threading apparatus and the sheet metal or profile strip and this intermediate profile is structurally bonded on the side of the hollow chamber profiles assigned to an inner side of the car body shell in each case to the hollow chamber profiles and on the side of the hollow chamber profiles assigned to an outer side of the car body shell is structurally bonded to the sheet metal or profile strip.

Here, the intermediate profile can have a rectangular or trapezoidal shape in cross-section. Insofar as a trapezoidal shape is provided for the intermediate profile, the longer of the parallel sides of the trapezoidal shape faces the threading aid.

Alternatively, the threading aid can be formed by a sliding seat, wherein one hollow chamber profile has webs projecting in the direction of the other hollow chamber profile, which webs engage into the other hollow chamber profile during bringing together of the hollow chamber profiles. The formation of the threading apparatus as a sliding seat also enables a prepositioning of the hollow chamber profiles relative to one another. In the case of this embodiment, it is advantageous if the edge portions, which face one another, of the hollow chamber profiles are structurally bonded in each case on their side assigned to an inner side of the car body shell in each case to a further sheet metal or profile strip.

The above-mentioned object is achieved in terms of a car body shell of a rail vehicle by a car body shell as claimed in claim 9. Preferred embodiments of this car body shell arise from claims 10 to 15 and have already been explained on the basis of the above description of a method for modular production of a car body shell.

An exemplary embodiment of the invention is explained in even greater detail below with reference to the drawings. In the drawings:

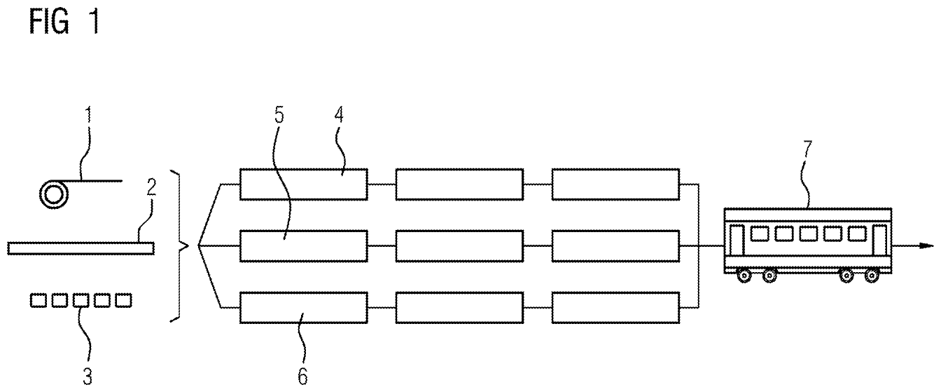

FIG. 1 shows a schematic representation of a process for a method for modular production of a car body shell of a rail vehicle,

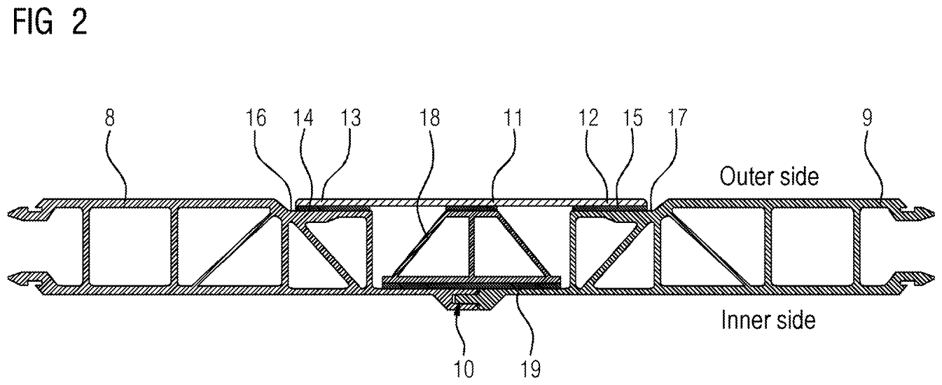

FIG. 2 shows a cross-sectional representation of a joining region between two hollow chamber profiles in a first embodiment and

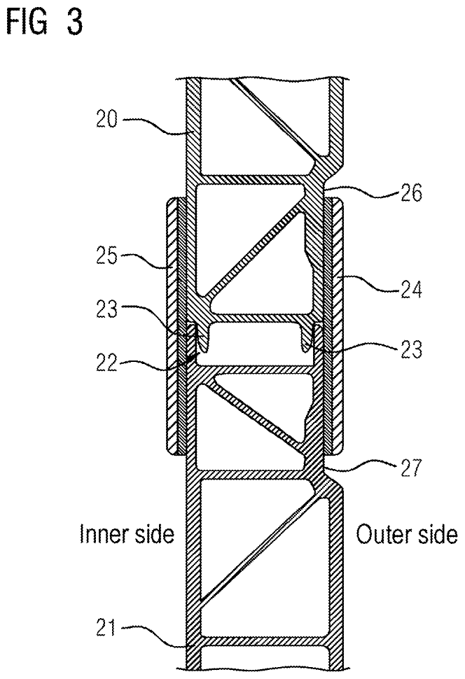

FIG. 3 shows a cross-sectional representation of a joining region between two hollow chamber profiles in a second embodiment.

FIG. 1 illustrates a method process for modular production of a car body shell of a rail vehicle. Initial materials/components are represented by way of example on the left in FIG. 1, namely an aluminum coil 1, a hollow chamber profile 2 and a number of windows 3. Various large assemblies of a rail vehicle can be manufactured from this in an integral design. The central part of FIG. 1 shows the parallel manufacture of the various large assemblies which takes place in a step a) of the production method, wherein, for example, the large assembly 4 can be a side wall, the large assembly 5 can be a roof and the large assembly 6 can be an underframe of a car body shell of a rail vehicle.

The respective large assemblies are produced in three exemplary manufacturing steps in the represented exemplary embodiment. In a last manufacturing step b) of the modular production method for a car body shell, the large assemblies previously manufactured parallel to one another are joined together by means of structural bonding to a car body shell. Cold-setting two-component construction adhesives based on epoxy resin or polyurethane should preferably be used for the structural bonding. The large assemblies 4, 5, 6 are thus part of the car body shell 7 which is composed overall from large assemblies which are structurally bonded to one another. The car body shell 7 can, for example, also have a head composed of fiber-reinforced plastic which is joined by means of structural bonding to the adjoining large assemblies “roof”, “side wall” and “base” manufactured, for example, in an aluminum integral design.

FIG. 2 shows a first exemplary embodiment for a joining region between two hollow chamber profiles 8, 9 which form in each case edge profiles of large assemblies which are to be joined to one another by means of structural bonding. The hollow chamber profiles 8, 9 form a threading apparatus on an inner side of the car body shell 7, which threading apparatus is embodied as a tongue/groove apparatus 10 and serves the purpose of prepositioning of the hollow chamber profiles 8, 9 for a subsequent bonding process. A sheet metal or profile strip 11 is provided on the outer side of the car body shell 7, the edge portions 12, 13, facing the hollow chamber profiles 8, 9, of which sheet metal or profile strip 11 are structurally bonded to the hollow chamber profiles 8, 9. In order to ensure a flush outer skin of the car body shell 7 in the joining region, the edge portions, facing one another, of the hollow chamber profiles 8, 9 have in each case on their sides assigned to an outer side of the car body shell a shoulder 16, 17. The height of the shoulders 16, 17 corresponds to a total height of the sheet metal or profile strip 11 and the respective adhesive layers 14 or 15.

In order to ensure sufficient strength of the bonding connection between the two hollow chamber profiles 8, 9, an intermediate profile 18 arranged between the tongue/groove apparatus 10 and the sheet metal or profile strip 11 is provided which has a trapezoidal shape in the present exemplary embodiment. The longer of the parallel sides of the trapezium is structurally bonded in each case to the hollow chamber profiles 8, 9 by means of a bonding layer 19 in the region of the threading apparatus 10. The shorter of the two parallel sides of the trapezium is also structurally bonded to the sheet metal or profile strip 11. The intermediate profile 18 is arranged centrally between the two hollow chamber profiles 8, 9.

FIG. 3 illustrates an alternative embodiment for a joining region between two hollow chamber profiles 20, 21. In the case of this embodiment, a threading apparatus is provided which is embodied as a sliding seat 22. For this purpose, the hollow chamber profile has webs 23 which project in the direction of the hollow chamber profile 21, which webs 23 engage into the hollow chamber profile 21 during bring together of the hollow chamber profiles 20, 21 and thus serve the purpose of prepositioning the hollow chamber profiles 20, for a subsequent bonding process.

A sheet metal or profile strip 24 which is structurally bonded to overlapping portions of the hollow chamber profiles 20, 21 is again used on an outer side of the car body shell 7. A further sheet metal or profile strip 25 which is in turn structurally bonded to overlapping portions of the hollow chamber profiles 20, 21 is provided on the inner side of the car body shell 7.

As in the first exemplary embodiment for a joining region between two hollow chamber profiles according to FIG. 1, the hollow chamber profiles 20, 21 have, on an outer side of the car body shell 7, shoulders 26, 27 so that a flush outer skin of the car body shell can be obtained.

The method represented on the basis of FIG. 1 for modular production of a car body shell can be used for all large assemblies of the car body shell 7 which are selected from the group which comprises an underframe, a side wall, a roof, an end wall and a head of the car body shell. The configuration of the joining regions according to the alternative embodiments of FIGS. 2 and 3 assumes that the large assemblies to be joined to one another by structural bonding are manufactured in integral design. A transfer of the bonding processes to large assemblies which are produced in differential design is readily possible provided that the relevant contours included in the joining process of the hollow chamber profiles 8, 9 or 20, 21 of differential design are taken over. Should one of the large assemblies involved in the joining process be composed of fiber-reinforced plastic, an external contour involved in the joining process of such a large assembly and of the corresponding contour would likewise have to possess one of the hollow chamber profiles 8, 9, 20, 21 described in greater detail above.

1-15. (canceled)

16. A method for modular production of a car body shell of a rail vehicle, the method comprising consecutive steps as follows:
a) parallel manufacturing of at least two large assemblies, directly adjoining one another, of the car body shell, and selecting the at least two large assemblies from a group including an underframe, a side wall, a roof, an end wall and a head of the car body shell; and
b) joining the at least two large assemblies, manufactured parallel to one another from step a), by structural bonding.

17. The method according to claim 16, which further comprises in step a) parallel manufacturing to one another of all of the large assemblies of the car body shell, and in step b) joining all of the large assemblies of the car body shell to one another by structural bonding.

18. The method according to claim 16, which further comprises:
forming edge portions, facing one another, of the large assemblies to be joined to one another, from hollow chamber profiles;
providing sides, facing one another, of the hollow chamber profiles with a threading apparatus for prepositioning of the hollow chamber profiles relative to one another;
using a sheet metal or profile strip overlapping the hollow chamber profiles to interconnect sides, associated with an outer side of the car body shell, of the hollow chamber profiles; and
structurally bonding the edge portions, facing the hollow chamber profiles, of the sheet metal or profile strip to the hollow chamber profiles.

19. The method according to claim 18, which further comprises:
providing each of the edge portions, facing one another, of the hollow chamber profiles with a respective shoulder on sides of the hollow chamber profiles associated with the outer side of the car body shell;
providing the shoulders in a region where the sheet metal or profile strip is structurally bonded to the respective hollow chamber profile; and
adapting a height of the shoulder to a height extent of the sheet metal or profile strip and a structural bonding layer.

20. The method according to claim 18, which further comprises forming the threading apparatus as a tongue and groove apparatus disposed on a side of the hollow chamber profiles associated with an inner side of the car body shell.

21. The method according to claim 20, which further comprises:
in step b) placing an intermediate profile between the threading apparatus and the sheet metal or profile strip;
structurally bonding the intermediate profile on the side of the hollow chamber profiles associated with the inner side of the car body shell to each of the hollow chamber profiles; and
structurally bonding the intermediate profile on the side of the hollow chamber profiles associated with the outer side of the car body shell to the sheet metal or profile strip.

22. The method according to claim 18, which further comprises:
forming the threading apparatus as a sliding seat;
providing one of the hollow chamber profiles with webs projecting in a direction of another of the hollow chamber profiles; and
engaging the webs into the other hollow chamber profile while bringing the hollow chamber profiles together.

23. The method according to claim 22, which further comprises structurally bonding each of the edge portions, facing one another, of the hollow chamber profiles, on a side associated with an inner side of the car body shell, to a further sheet metal or profile strip.

24. A car body shell of a rail vehicle, the car body shell comprising:
large assemblies directly adjoining one another, said large assemblies being selected from a group including an underframe, two side walls, a roof, two end walls or one end wall and a head of the car body shell;
two of said large assemblies directly adjoining one another having edge portions, facing one another, formed from hollow chamber profiles;
a sheet metal or profile strip overlapping said hollow chamber profiles;
said hollow chamber profiles having sides, facing one another, with a threading aid for prepositioning of said hollow chamber profiles relative to one another;
said hollow chamber profiles having sides, associated with an outer side of the car body shell, being interconnected by said sheet metal or profile strip; and
said sheet metal or profile strip having edge portions, facing said hollow chamber profiles each being structurally bonded to a respective one of said hollow chamber profiles.

25. The car body shell according to claim 24, which further comprises:
a structural bonding layer;
said edge portions, facing one another, of said hollow chamber profiles each having a respective a shoulder on sides of said hollow chamber profiles associated with an outer side of the car body shell;
said shoulders each being disposed in a region having said sheet metal or profile strip structurally bonded to said respective hollow chamber profiles; and
a height of each shoulder corresponding to a height extent of said sheet metal or profile strip and said structural bonding layer.

26. The car body shell according to claim 24, wherein said threading aid is a tongue and groove apparatus disposed on a side of said hollow chamber profiles associated with an inner side of the car body shell.

27. The car body shell according to claim 26, which further comprises an intermediate profile disposed between said threading apparatus and said sheet metal or profile strip, said intermediate profile being structurally bonded to said hollow chamber profiles on the side of said hollow chamber profiles associated with the inner side of the car body shell, and said intermediate profile being structurally bonded to said sheet metal or profile strip on a side of said hollow chamber profiles associated with the outer side of the car body shell.

28. The car body shell according to claim 27, wherein said intermediate profile is rectangular or trapezoidal.

29. The car body shell according to claim 24, wherein said threading apparatus is a sliding seat, one of said hollow chamber profiles has webs projecting in a direction of another of said hollow chamber profiles, and said webs engage into said other hollow chamber profile upon bringing said hollow chamber profiles together.

30. The car body shell according to claim 29, which further comprises a further sheet metal or profile strip, said edge portions, facing one another, of said hollow chamber profiles, being structurally bonded to said further sheet metal or profile strip on a side of said hollow chamber profiles assigned to the inner side of the car body shell.
